(19) United States
(12) Patent Application Publication
(10) Pub. No.: US 2016/0261609 A1
(43) Pub. Date: Sep. 8, 2016

(54) SYSTEM AND A METHOD FOR INTELLIGENT VERIFICATION MANAGEMENT

(71) Applicant: Infointeg (Pty) Limited, Johannesburg (ZA)

(72) Inventors: Kevin Dale Derman, Johannesburg (ZA); Shana Kay Derman, Johannesburg (ZA)

(73) Assignee: INFOINTEG (PTY)LIMITED

(21) Appl. No.: 15/059,606

(22) Filed: Mar. 3, 2016

(30) Foreign Application Priority Data
Mar. 3, 2015 (ZA) 2015/01513

(51) Int. Cl. H04L 29/06

(52) U.S. Cl. CPC H04L 63/126; H04L 63/0428

(57) ABSTRACT

The invention relates to a computer-implemented system and a corresponding method for intelligent verification management between a browser and a web server. The system comprises a web server, serving up a provider's website and associated web pages via the Internet to potential browsers; a non-transitory computer readable storage medium, in communication with the web server, storing computer-executable instructions; means for establishing an encrypted connection between the web server and a browser of such website, in the form of a a non-transitory computer accessible accreditor; and means for identifying, assessing and verifying a preselected form of provider accreditation as required by the browser in accordance with set performance criteria, in the form of a non-transitory computer accessible accreditor; ensuring that branded or user data passes between the web server and the browser in a secure, authorised and confidential manner online in accordance with preselected level of confidentiality, integrity, authentication and accreditation.

### FIELD OF THE INVENTION

The invention relates to a system and a method for verifying and managing the verification of identity usage, such as the use of proprietary data, logos, trade marks and other brand related subject matter.

### BACKGROUND TO THE INVENTION

The creation and use of identity specific subject matter such as trade marks, logos and the like in relation to specific persons, their products and/or services have become common practice in modern business.

For the purposes of this specification, the term “data” means information in a form that can be input to, created by, processed by, stored in, and output by a computer, and includes of characters such as letters, numbers and images, the term “branded subject matter” or, more particularly, “branded data” means data that indicate a connection between such data, on the one side, and the identity, products and/or services of a specific supplier, be it a natural or legal person, on the other side, the term “user” means a person accessing (using) the Internet, the term “browser” means an Internet user's computer, the term “web server” means such supplier's computer that deliver or serves up its website and the web pages thereon with the use of web server programs and Hypertext Transfer Protocol (“HTTP”) to users, in response to their requests, the term “customer” means a user that has a commercial relationship with a supplier and who communicates in terms of that relationship with the supplier's web server via the Internet with the use of its browser, and the term “RSP” means regulatory strategic partnering, as required by law from certain suppliers in certain territories.

The introduction and application of the Internet and websites, displaying branded data on one or more web pages often pertaining to a specific supplier, has simplified access and use of branded data for authorised users as well as, unfortunately, for unauthorized users.

The need for suppliers, particularly those that allow web access and/or make use of membership programmes over the Internet, to control such access to branded data and more particularly, the use thereof, in an endeavour to protect the branded data against abuse has become material to the success of such access and usage.

Various forms of protection have been developed since the introduction of the Internet, such as Symantec, TrustE, DigiCert, GeoTrust, Thawte, Coursera and Open Bages, enabling suppliers to receive, collect and/or use branded, or customer data safely across their customer, employee and vendor channels by establishing secure encrypted connections between browsers and web servers.

Most forms of such protection were developed to secure suppliers and other proprietors against the abuse of branded or proprietary data, using technologies or processes such as a so-called Secure Sockets Layer (“SSL”). An SSL is a form of security technology that establishes an encrypted connection or link between a web server and a browser of a specific website. This connection or link ensures that all data, including branded or proprietary data, passes from a website between the web server and the browser in a secure, authorised and confidential manner online.

A more modern version of an SSL is a so-called Transport Layer Security (“TLS”). Both an SSL and a TLS utilise cryptographic protocols designed to provide communication security over the Internet, typically using International Telecommunication Union (“IRU”) standard certificates with asymmetric cryptography to authenticate a browser with an authorised key arrangement and the encryption of the data between the website and the browser. Preferably, these means of protection allow for data confidentiality, integrity and authentication.

Typically, a website utilising an SSL displays a padlock device or icon in the browsers' URL, notifying or alerting users of the use of such protection to a browser. Another form of identification used to indicate secure websites is a so-called trust seal. A trust seal is usually granted by a protection provider to supplier websites or businesses for display so as to reflect or illustrate the supplier's concern for security and identity, typically also indicating sound security practices such as secure transaction methodologies, verified supplier existence and periodic re-validation.

The SSL and the TLS are of the most widely deployed security protocols used today. Each of these protocols is primarily transparent and requires little interaction from the end user when establishing a secure session, but for being notified of or alerted to the presence of an SSL or a TLS by the display of these padlock icons, green bars or trust seals.

However, most of the existing forms of intelligent verification management systems and methods address the issue of secure access and connection with the associated data protection without means for identifying, assessing and/or verifying other forms of accreditations commonly sought in modern business.

### OBJECT OF THE INVENTION

It is therefore an object of the invention to provide a novel and innovative intelligent verification management system and method, with associated trust seals, capable of identifying, assessing, verifying and/or certifying other forms of accreditations commonly sought in modern business.

### SUMMARY OF THE INVENTION

According to a first aspect of the invention there is provided a computer-implemented system for intelligent verification management between a browser and a web server comprising
a web server, serving up a provider's website and associated web pages via the Internet to potential browsers;
a non-transitory computer readable storage medium, in communication with the web server, storing computer-executable instructions;
means for establishing an encrypted connection between the web server and a browser of such website; and
means for identifying, assessing and verifying a preselected form of provider accreditation as required by the browser in accordance with set performance criteria;
   ensuring that branded or user data passes between the web server and the browser in a secure, authorised and confidential manner online in accordance with preselected level of confidentiality, integrity, authentication and accreditation.

The system may include a non-transitory computer accessible accreditor, for identifying, assessing and verifying the preselected, browser required form of provider accreditation, preferably in the form of a trust seal, to pass authorised branded and user data between the web server and the browser online in accordance with preselected level of confidentiality, integrity, securitization and authentication; and

a non-transitory computer accessible connector, for establishing the encrypted connection between the web server and a browser of such website.

The accreditor may conceal preselected data within a provider's other non-confidential data, such as within its logo, to communicate visually a positive or negative outcome of a verification process.

The system may be provided with functionality tools selected from the group comprising a verification management tool, a strategic partnering tool, a green intervention tool, a monitoring tool, a mailing tool, a social media platform tool, a printing tool, a trust seal tool, an educational qualification tool and a listing tool, for monitoring verifying and protecting a supplier's branded data as well as its strategic partnering, green intervening, social media platforms, original certificates, qualifications, associations and affiliation in their electronic communications, while providing a trust seal therefor.

The verification management tool may include a QR scanning verification tool, capable of providing both digital and tangible outcomes, the QR scanning verification tool preferably having both computer implemented and cellular implemented functionality.

According to a second aspect of the invention there is provided a computer-implemented method for managing intelligent verification between a browser and a specific web server, serving up an associated provider's website and associated web pages containing branded data via the Internet to potential browsers with the use of a non-transitory computer readable storage medium, in communication with the web server and storing computer-executable instructions, the method including the steps of:
establishing an encrypted connection between the web server and a browser of such website;
identifying, assessing and verifying a preselected form of provider accreditation as required by the browser in accordance with set performance criteria; and
ensuring that branded and user data passes between the web server and the browser in a secure, authorised and confidential manner online in accordance with preselected level of confidentiality, integrity and authentication.

The method may include the step of:

using a non-transitory computer accessible connector, for establishing the encrypted connection between the web server and the browser; and

a non-transitory computer accessible accreditor, for identifying, assessing and verifying the preselected, browser required form of provider accreditation, preferably in the form of a trust seal;

to pass the authorised branded and user data between the web server and the browser online in accordance with preselected level of confidentiality, integrity, securitization and authentication.

The use of the accreditor may include the step of concealing preselected data within a provider's other non-confidential data, such as within its logo, to communicate visually a positive or negative outcome of a verification process.

The method may further include any one or more of the steps selected from the group comprising managing the verification and protection of branded and user data, verifying the strategic partnering of a supplier, verifying the green intervening of a supplier, monitoring the location and use of branded data, reflecting the trust seal of a supplier's associations and affiliation in their electronic communications, verifying a supplier's social media platforms, verifying and printing supplier's original certificates, providing a trust seal and verifying educational qualifications for monitoring verifying and protecting a supplier's branded data as well as its strategic partnering, green intervening, social media platforms, original certificates, qualifications, associations and affiliation in their electronic communications, while providing the trust seal therefor.

The step of managing the verification and protection of branded or user data may include a QR scanning verification step, providing both digital and tangible outcomes, the QR scanning verification step preferably being implemented with both computer implemented and cellular implemented functionality.

According to third aspect of the invention there is provided a web enabled trust seal for intelligent verification between a browser and a web server on a computer-implemented intelligent verification management system, comprising a web server, serving up a provider's website and associated web pages via the Internet to potential browsers, a non-transitory computer readable storage medium, in communication with the web server, storing computer-executable instructions, means for establishing an encrypted connection between the web server and a browser of such website, and means for identifying, assessing and verifying a preselected form of provider accreditation as required by the browser in accordance with set performance criteria, the trust seal characterised in identifying, assessing and verifying in real time preselected, browser required form of provider accreditation while authorised branded and user data is passed between the web server and the browser online in accordance with a preselected level of confidentiality, integrity, securitization and authentication.

### DETAILED DESCRIPTION OF THE INVENTION

A preferred embodiment of the invention shall now be described with reference to the accompanying diagrams wherein:

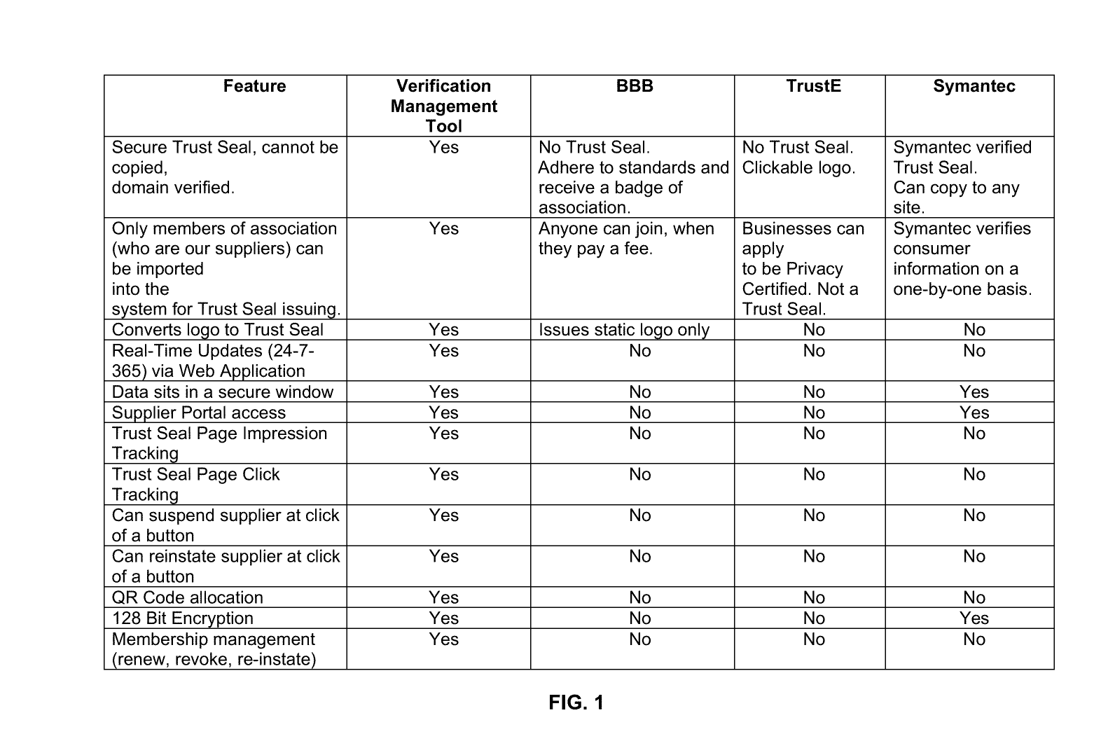

FIG. 1 is a diagrammatic comparison between a verification management tool in accordance with the invention and existing tools;

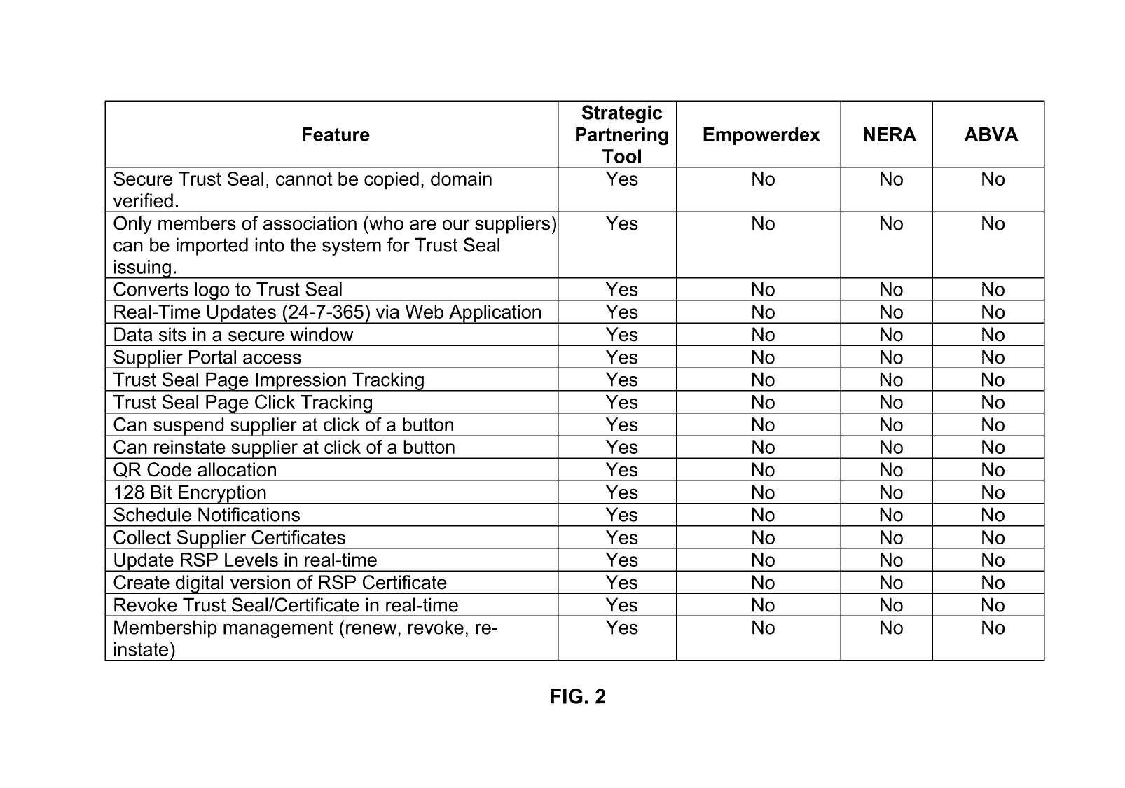

FIG. 2 is a diagrammatic comparison between a strategic partnering tool in accordance with the invention and existing tools;

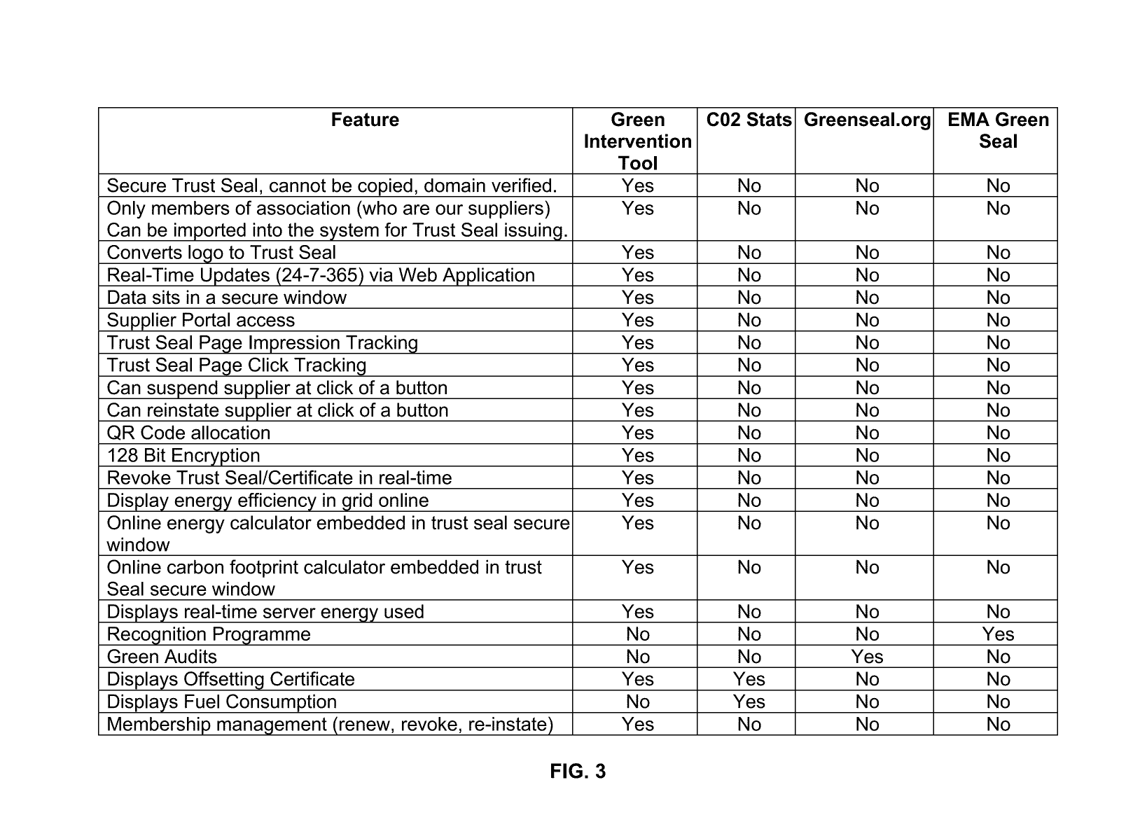

FIG. 3 is a diagrammatic comparison between a green intervention tool in accordance with the invention and existing tools;

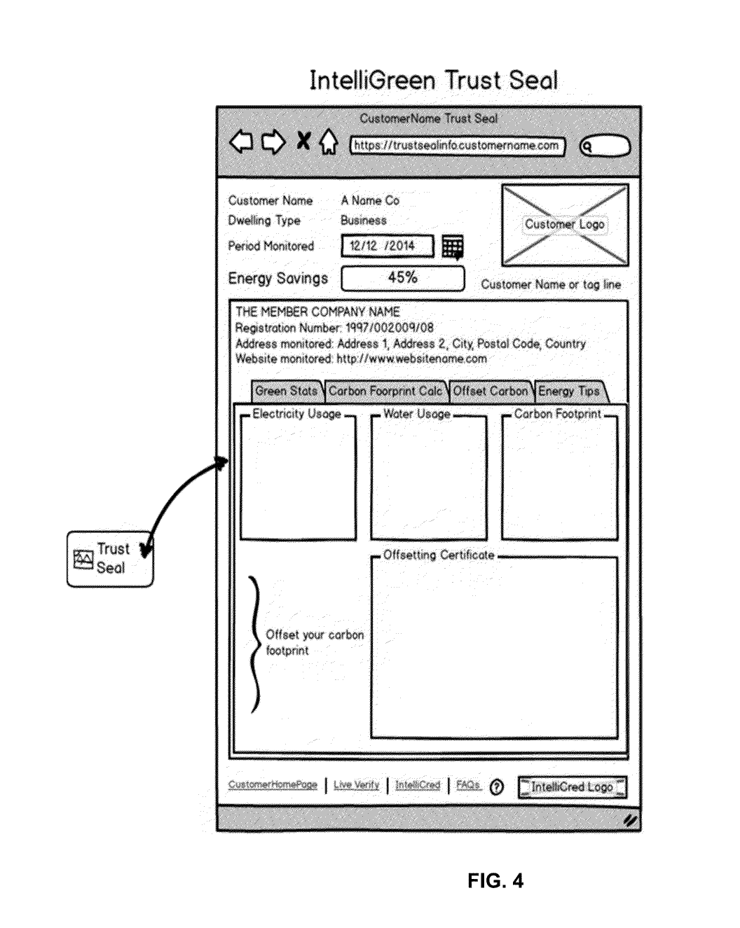

FIG. 4 is an illustration of a screen layout for a green intervention tool as depicted in FIG. 3;

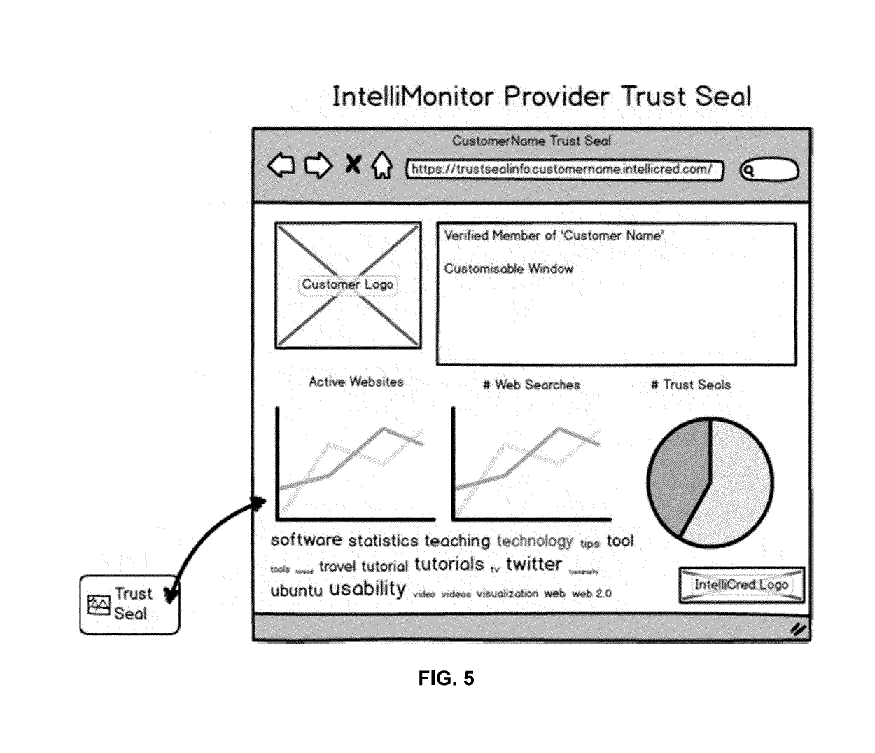

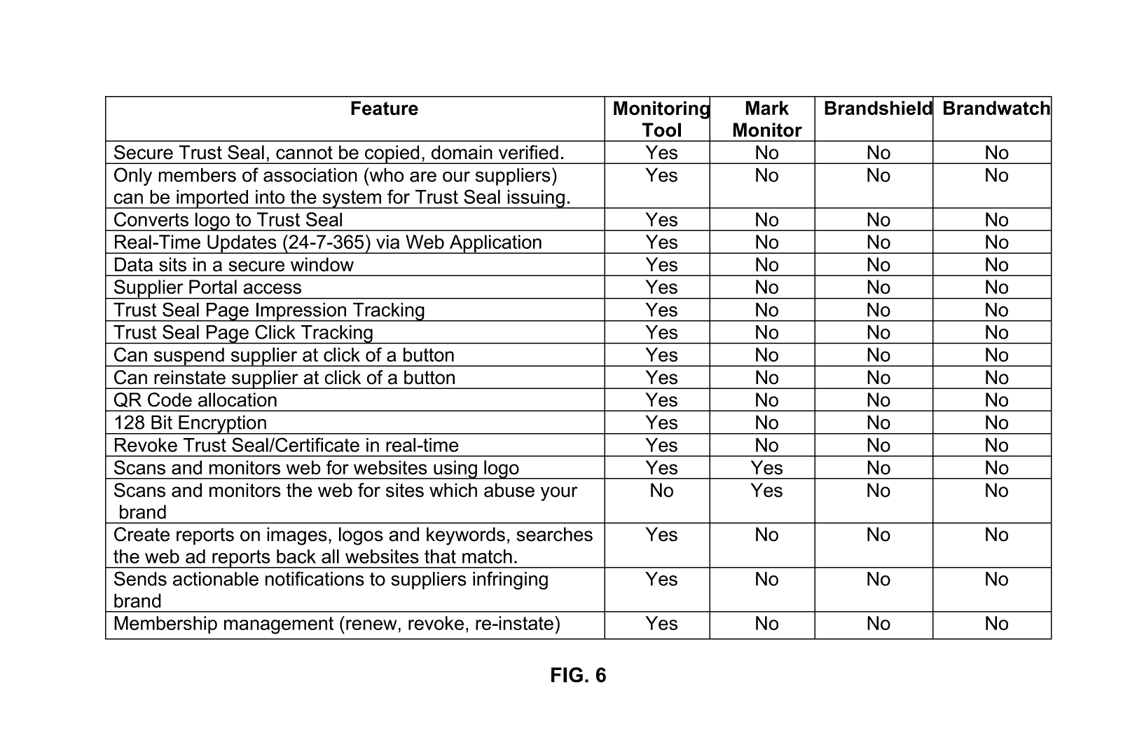

FIG. 5 an illustration of a screen layout for a monitoring tool as depicted in FIG. 6;

FIG. 6 is a diagrammatic comparison between a monitoring tool in accordance with the invention and existing tools;

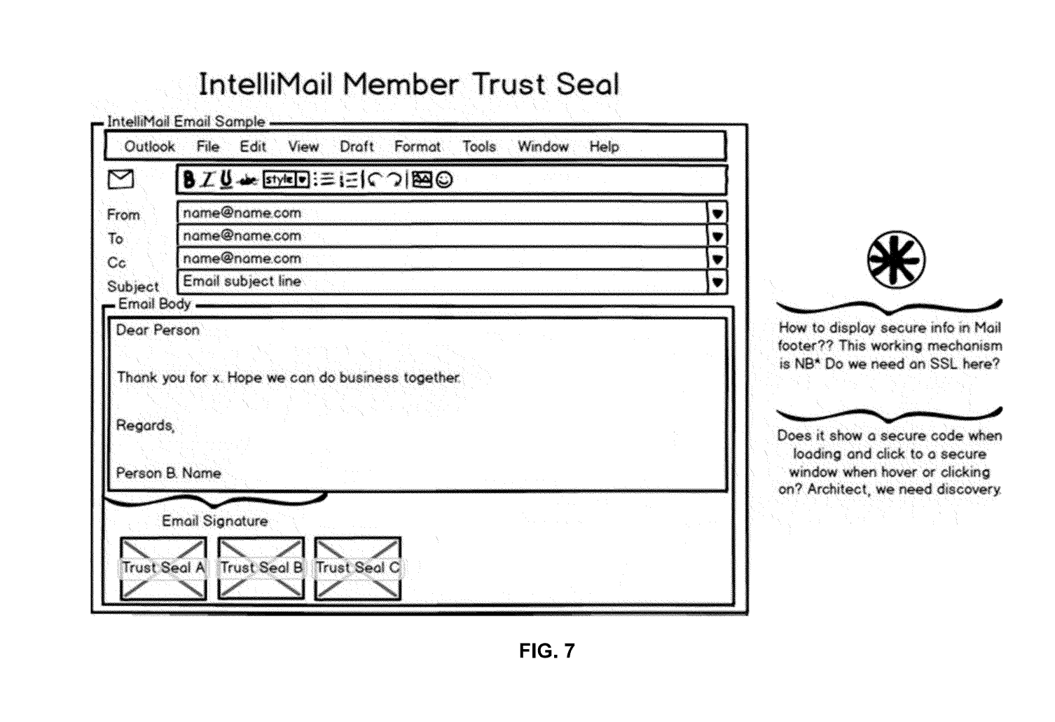

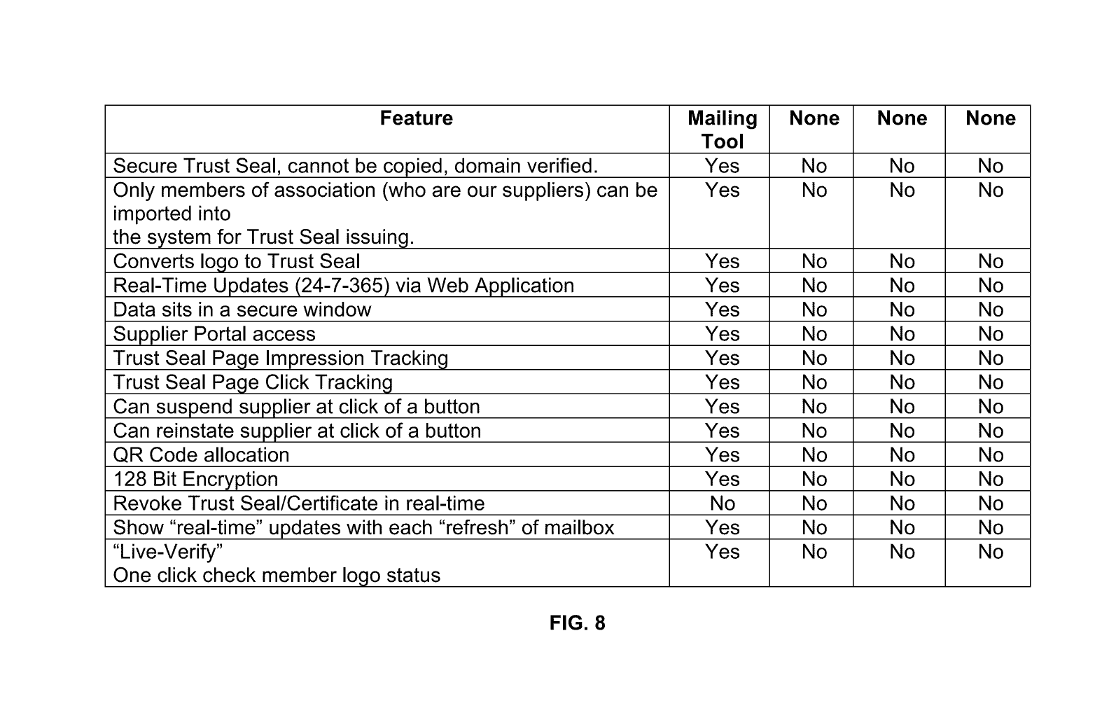

FIG. 7 is an illustration of a screen layout for a mailing tool as depicted in FIG. 8;

FIG. 8 is a diagrammatic comparison between a mailing tool in accordance with the invention and existing tools;

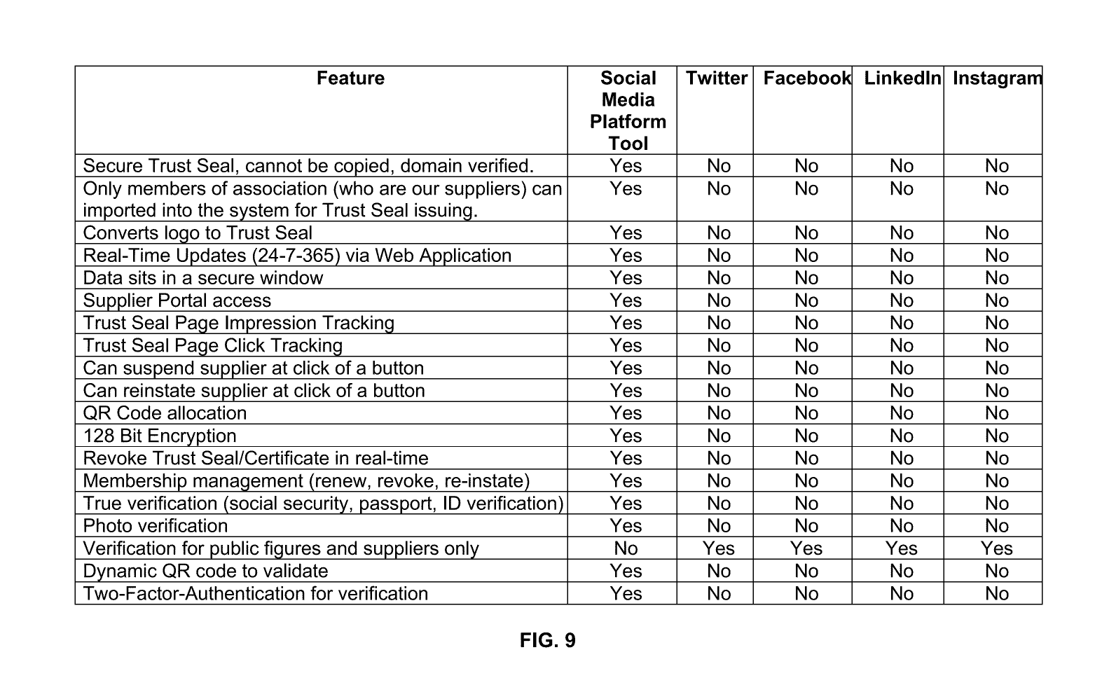

FIG. 9 is a diagrammatic comparison between a social media platform tool in accordance with the invention and existing tools;

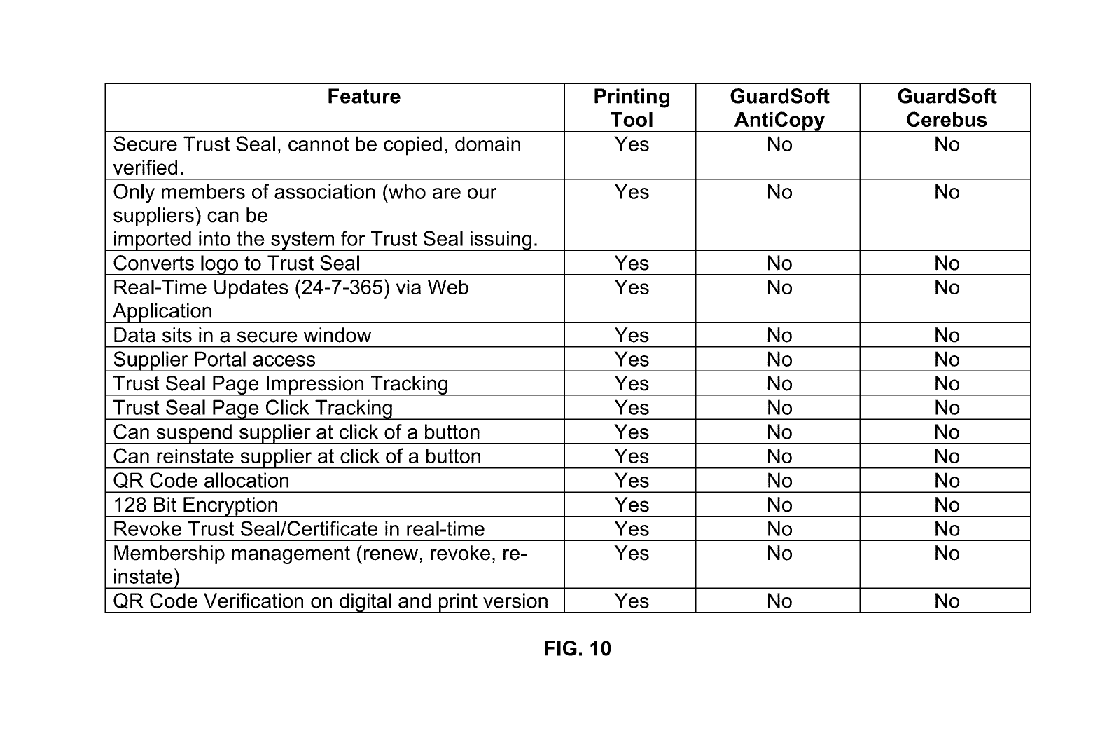

FIG. 10 is a diagrammatic comparison between a printing tool in accordance with the invention and existing tools;

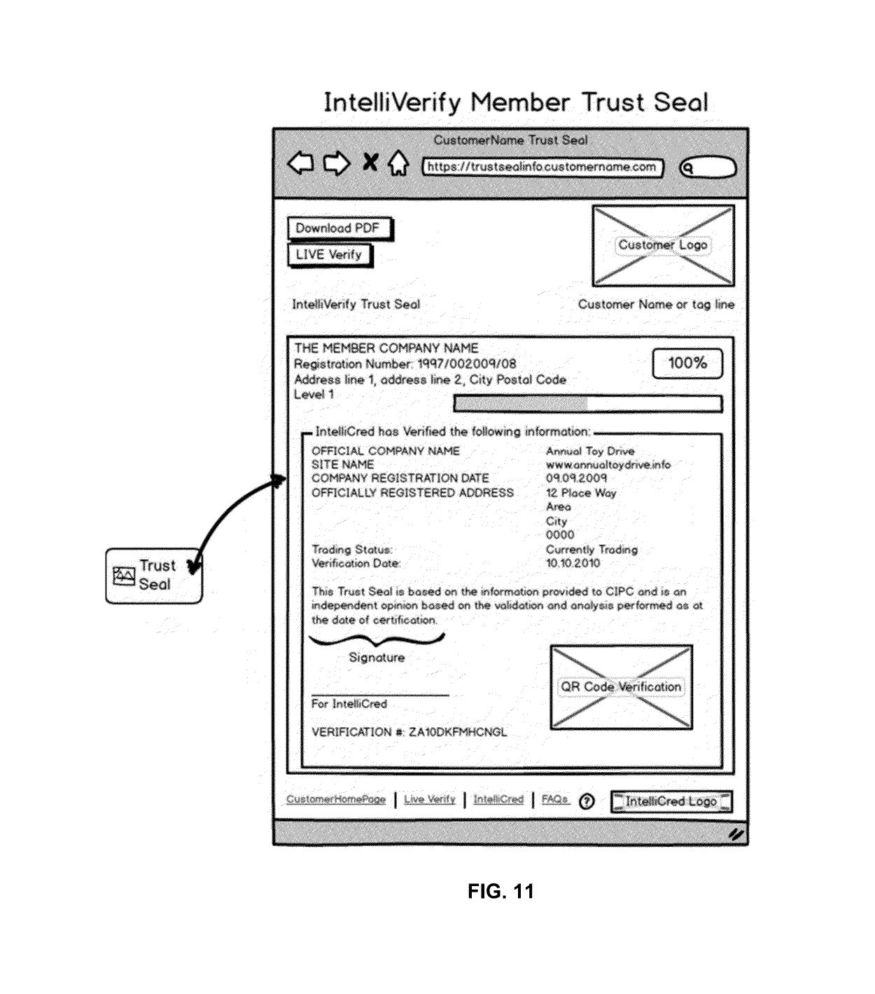

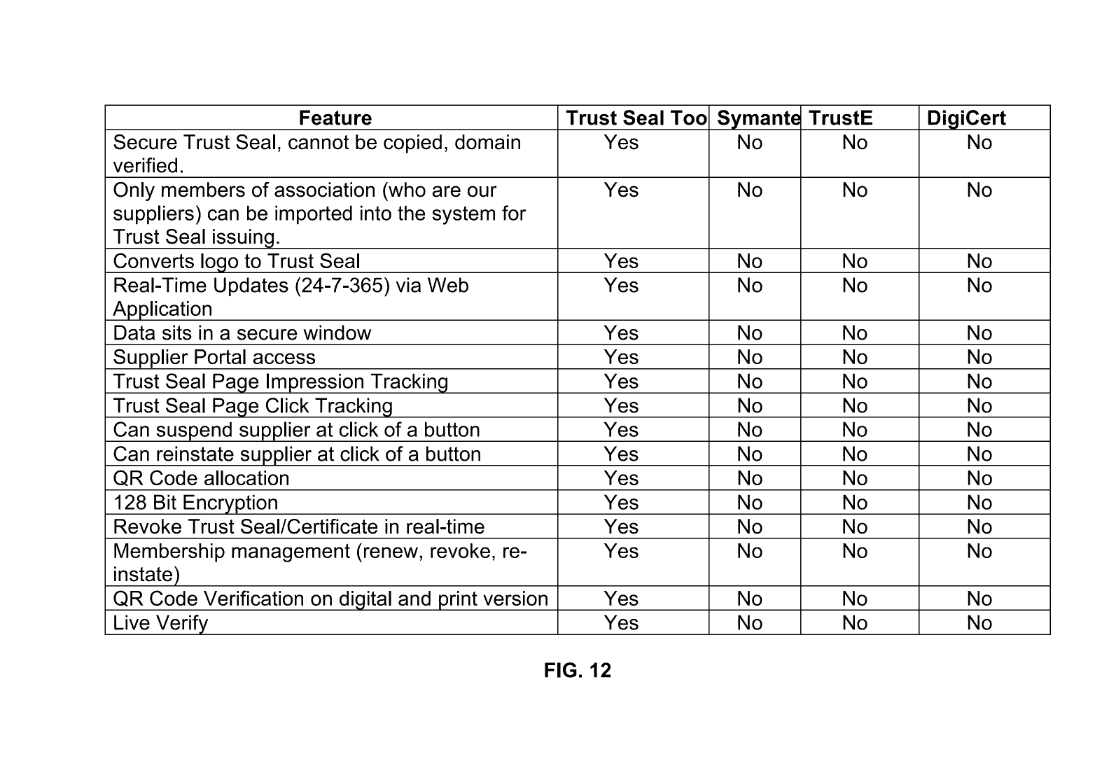

FIG. 11 is an illustration of a screen layout for a trust seal as depicted in FIG. 12;

FIG. 12 is a diagrammatic comparison between a trust seal tool in accordance with the invention and the prior art tools;

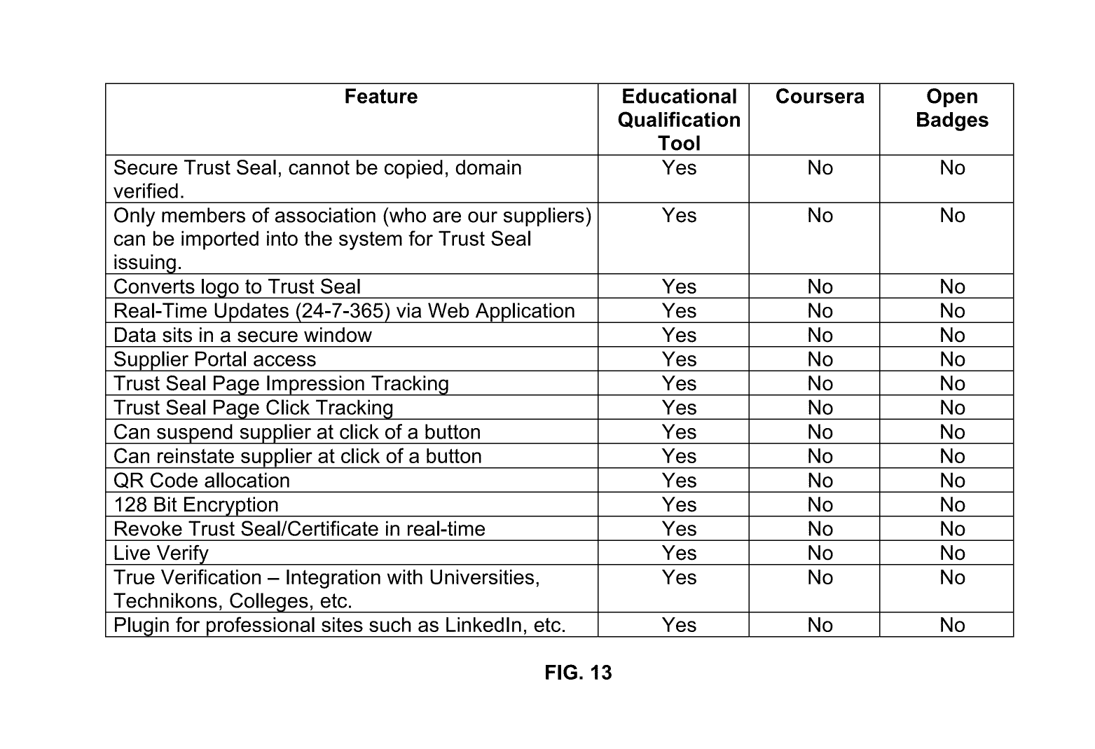

FIG. 13 is a diagrammatic comparison between an educational qualification tool in accordance with the invention and existing tools;

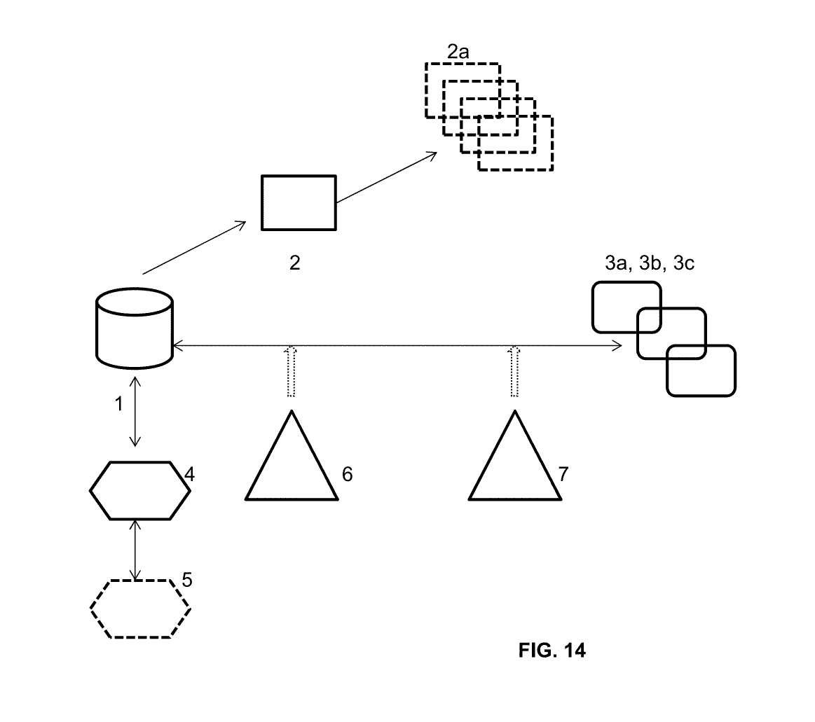

FIG. 14 is a diagrammatic layout of the physical components of the system in accordance with the invention; and

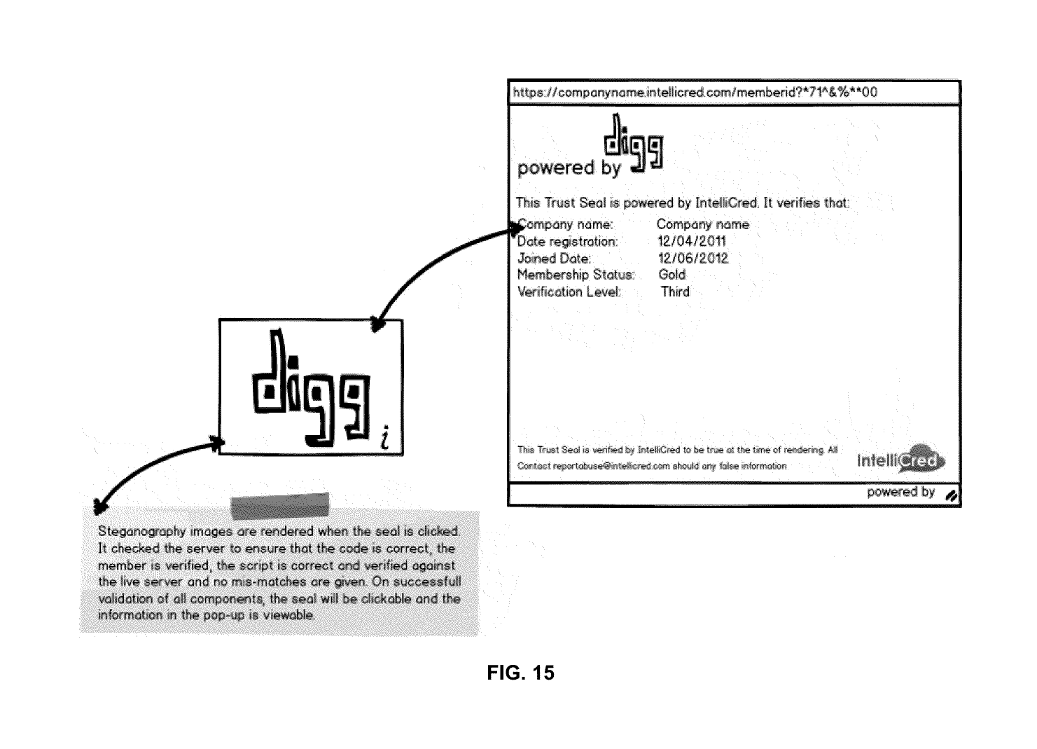

FIG. 15 is a representation of a visual image, generated from concealed preselected data within a provider's other non-confidential logo, to communicate visually a positive or negative outcome of a verification process in accordance with the invention.

A system for intelligent verification management of access and usage of branded data in accordance with the invention and as illustrated in the accompanying FIGS. 1 to 15 between a provider's web server and browsers includes a specific provider's web server 1, serving up a provider's website 2 and associated web pages 2a via the Internet to potential browsers 3a, 3b and 3c, a non-transitory computer readable storage medium 4, in communication with the web server and storing computer-executable instructions 5, means 6 for establishing an encrypted connection between the web server and a browser of such website, and means 7 for identifying, assessing and verifying a preselected form of provider accreditation as required by the browsers in accordance with set performance criteria; ensuring that branded or user data passes between the web server and the browsers in a secure, authorised and confidential manner online in accordance with preselected level of confidentiality, integrity, authentication and accreditation.

The means for identifying, assessing and verifying the preselected, browser required form of provider accreditation is in the form of a non-transitory computer accessible accreditor 7, to pass authorised branded and user data between the web server 1 and the browsers 3a, 3b and 3c online in accordance with preselected level of confidentiality, integrity, securitization and authentication. The means for establishing the encrypted connection between the web server 1 and the browsers 3a, 3b and 3c is in the form of a non-transitory computer accessible connector 6.

The non-transitory computer accessible accreditor 7 conceals preselected data within a provider's other non-confidential logo, as illustrated in FIG. 15, to communicate visually a positive or negative outcome of a verification process by way of suitable steganographic technology.

The system further includes a group of functionality tools including a verification management tool, provided with a QR scanning verification functionality, capable of providing both digital and tangible outcomes, based on a computer implemented and a cellular implemented platform, and a review functionality; a strategic partnering tool, providing a digital outcome; a green intervention tool; a monitoring tool, including child-safety monitoring functionality, providing a digital outcome; a mailing tool, providing a digital outcome; a social media platform tool, providing a digital outcome; a printing tool, providing both a digital and a tangible outcome; a trust seal tool, providing a digital outcome; an educational qualification tool, providing both a digital and a tangible outcome; a verified supplier listing tool, providing both a digital and a tangible outcome; a recruitment verification tool, providing both a digital and a tangible outcome; a verified software detection tool, providing a digital outcome; a QR scanning verification tool, providing both a digital and a tangible outcome; a review verification tool, providing a digital outcome; a digital identification tool, providing a digital outcome; and a recycling tool, providing a tangible outcome.

The verification management tool, with reference to FIG. 1, enables businesses to control, monitor, monetize and protect instances of their logos on the web against logo abuse.

The verification management tool, forming the hub of the system, incorporates three layers of security on both a website's server-side and browser or client-side. The three layers comprise firstly, of an SSL protocol, utilising a security level with a preselected level of encryption technology, secondly, application wrapping, which allows only for certain information or data exchange, and thirdly, a secure mechanism of distribution.

The verification management tool is in the form of a white label business-to-business application, converting a conventional logo into a security based digital trust seal, barring the copying of the date to another website to the need for domain verification.

The verification management tool structuring includes features such as a secure trust seal that cannot be copied and is domain verified, only preselected members can be imported into the system for trust seal issuing, the conversion of the logo to a trust seal, real-time updating via web application, the branded data is placed in a secure window, allows for preselected supplier portal access, enables trust seal page impression tracking, enables suspension of trust seal page click tracking, enables suspension of supplier at click of a button, enables reinstatement of a supplier at click of a button, enables QR code allocation, enables 128 bit encryption, enables membership management (renew, revoke, re-instate), and monitoring and reporting on location and use of logos from credible members matched with those not vetted.

The strategic partnering tool, with reference to FIG. 2, is in a white label, cloud format, incorporating a notifications sub-tool, arranged to collect periodically updated supplier certificates in order to verify third party partnering status or accreditation.

The strategic partnering tool incorporates means for converting a PDF version of a supplier certificate into an easy-to-read digital trust seal format and for printing the created trust seal version with a QR code after verification of the validity of the printed certificate.

The strategic partnering tool structuring includes features such as a secure trust seal that cannot be copied and is domain verified, only preselected members can be imported into the system for trust seal issuing, converts logo to trust seal, real-time updates (24-7-365) via web application, data sits in a secure window, supplier portal access, trust seal page impression tracking, trust seal page click tracking, can suspend a supplier at click of a button, can reinstate a supplier at click of a button, QR code allocation, 128 bit encryption, schedule notifications, collect supplier certificates, update RSP levels in real-time, create digital version of RSP certificate, revoke trust seal/certificate in real-time, membership management (renew, revoke, re-instate), and export reports and save results.

The green intervention tool, with reference to FIG. 3, is in a white label, cloud format, incorporating a notifications sub-tool, arranged to reflect a supplier's green interventions for triple line reporting and financial auditing.

The green intervention tool incorporates a standard green (trust) seal, as shown in FIG. 4, that when clicked, displays the supplier's energy use for the month in a graph and its carbon footprint in a visual with preselected additional information that the supplier wishes to reflect from time to time.

The green intervention tool structuring includes features such as that the secure trust seal cannot be copied and is domain verified, only members who are approved suppliers can be imported into the system for trust seal issuing, converts logo to trust seal, real-time updates (24-7-365) via web application, data sits in a secure window, supplier portal access, trust seal page impression tracking, trust seal page click tracking, can suspend supplier at click of a button, can reinstate supplier at click of a button, QR code allocation, 128 bit encryption, revoke trust seal/certificate in real-time, display energy efficiency in grid online, online energy calculator embedded in trust seal secure window, online carbon footprint calculator embedded in trust seal secure window, displays real-time server energy used, recognition programme, green audits, displays offsetting certificate, displays fuel consumption, and membership management (renew, revoke, re-instate).

The monitoring tool, with reference to 5, is in a white label, cloud format, capable of assisting suppliers who want to control where their branded data is situated, but do not have any suitable tools to do so.

The monitoring tool crawls the web, searching for specific branded data, such as specific logos, trade marks and the like and reports back to the supplier, as reflected in FIG. 5.

The monitoring tool structuring includes features such as a secure trust seal that cannot be copied and is domain verified, only members who are approved suppliers can be imported into the system for trust seal issuing, converts logo to trust seal, real-time updates (24-7-365) via web application, data sits in a secure window, supplier portal access, trust seal page impression tracking, trust seal page click tracking, can suspend supplier at click of a button, can reinstate supplier at click of a button, QR code allocation, 128 bit encryption, revoke trust seal/certificate in real-time, scans and monitors web for websites using logo, scans and monitors the web for sites which abuse your brand, create reports on images, logos and keywords, searches the web ad reports back all websites that match, sends actionable notifications to suppliers infringing brand and membership management (renew, revoke, re-instate).

The monitoring tool further could incorporate additional functionality in the form of a back-end value-add, comprising reverse phrase lookups, in addition to image lookups, enabling a search for specific subject matter such as logos, phrases and/or mentions in social media sites.

The mailing tool, with reference to 7, is in a white label, cloud format, capable of assisting suppliers who do not have a web presence, but would like to show their trust seals of association/affiliation in their emails as part of their electronic signatures.

The mailing tool can stand alone or can be applied as a spin-off or associated tool with one or more of the other tools. A supplier can therefore use a mailing tool only or a supplier, that has a system for verifying and managing the verification of identity usage in accordance with the invention, can provide its members with a mailing tool only.

The mailing tool structuring includes features such as a secure trust seal that cannot be copied and is domain verified, only members of association (who are our suppliers) can be imported into the system for trust seal issuing, converts logo to trust seal, real-time updates (24-7-365) via web application, data sits in a secure window, supplier portal access, trust seal page impression tracking, trust seal page click tracking, can suspend supplier at click of a button, can reinstate supplier at click of a button, QR code allocation, 128 bit encryption, revoke trust seal/certificate in real-time, show “real-time” updates with each “refresh” of mailbox, “live-verify”, one click check member logo status, outgoing and incoming mail verification to reduce spam/phishing and spoofing mails and every mail is verified from sender to receiver.

The social media platform tool, with reference to 9, is in a white label, cloud format, capable of providing suppliers with a social media platform such as LinkedIn, Facebook, Twitter and the like, with verified profiles.

The social media platform tool is thus cable of assisting HR related suppliers requiring verified personal profiles.

The social media platform tool structuring includes features such as a secure trust seal that cannot be copied and is domain verified, only members of association (who are our suppliers) can be imported into the system for trust seal issuing, converts logo to trust seal, real-time updates (24-7-365) via web application, data sits in a secure window, supplier portal access, trust seal page impression tracking, trust seal page click tracking, can suspend supplier at click of a button, can reinstate supplier at click of a button, QR code allocation, 128 bit encryption, revoke trust seal/certificate in real-time, membership management (renew, revoke, re-instate), true verification (social security, passport, id verification), photo verification, verification for public figures and suppliers only, dynamic QR code to validate, and two-factor-authentication for verification.

The printing tool, with reference to 10, is in a white label, cloud format, capable of assisting suppliers who require original documents, such as periodically updated tax clearance certificates from the relevant receiver of revenue for verification purposes.

The supplier typically would print a first version of the document for their clients, the document receiving a barcode or QR code on the printout. The supplier can then show the document to whomever requires it, and the QR code can be scanned and be vetted against the issuer's database for validity.

The printing tool thus allows for less printing, enabling paper-saving and allowing suppliers to avoid visiting the issuer physically for an updated certificate each year.

The printing tool structuring includes features such as a secure trust seal that cannot be copied and is domain verified, only members of association (who are our suppliers) can be imported into the system for trust seal issuing, converts logo to trust seal, real-time updates (24-7-365) via web application, data sits in a secure window, supplier portal access, trust seal page impression tracking, trust seal page click tracking, can suspend supplier at click of a button, can reinstate supplier at click of a button, QR code allocation, 128 bit encryption, revoke trust seal/certificate in real-time, membership management (renew, revoke, re-instate), and QR code verification on digital and print version.

The printing tool further could incorporate additional functionality for use when printing labels for physical products with quality, content and/or origin certification, such as “a-grade”, “organic” or the like. it is envisaged that such functionality could operate in association with existing codification systems, such as QR coding, the trust seal, as hereinbefore described, and the like, thus disclosing predetermined, verified information on the source entity's website. it is further envisaged that an active verified trust seal is used on a printed label or similar article to enable, when say a QR code is scanned to assess the quality, content and/or origin of an product, the product provider and another entity to be credited in accordance with a commercially valuable benefit system, with such benefits including renewable energy certificates and the like.

The trust seal tool, with reference to FIGS. 11 and 12, is in a white label, cloud format, capable of assisting suppliers who wish to show an additional level of trust on the web, specifically on their website. The trust seal tool enables the verification of a supplier's branded data and display verified results in a pop-up window.

The trust seal tool structuring includes features such as secure trust seal, cannot be copied, domain verified, only members of association (who are our suppliers) can be imported into the system for trust seal issuing, converts logo to trust seal, real-time updates (24-7-365) via web application, data sits in a secure window, supplier portal access, trust seal page impression tracking, trust seal page click tracking, can suspend supplier at click of a button, can reinstate supplier at click of a button, QR code allocation, 128 bit encryption, revoke trust seal/certificate in real-time, membership management (renew, revoke, re-instate), QR code verification on digital and print version, and live verify.

In addition, the trust seal tool structuring enables verification and review functionality and include features such as IP blacklisting assessments against recognized preselected sites such as whatismyipaddress.com/blacklist-check, email blacklisting assessments against recognized preselected sites such as mxtoolbox.com/blacklists.aspx, supplier name and registration number, address via google earth (physical existence), address via utility bill, without reliance on scanned or uploaded copies of utility bills but with selection of predetermined and selected utilities where proprietary API would conduct verification and review automatically, telephone (mobile and/or landline), domain (internet address), email address: existence, domain blacklisting, and email blacklisting.

The educational qualification tool, with reference to 13, is in a white label, cloud format, capable of assisting suppliers who procuring or reflecting the educational qualifications of their members.

The educational qualification tool structuring includes features such as secure trust seal, cannot be copied, domain verified, only members of association (who are our suppliers) can be imported into the system for trust seal issuing, converts logo to trust seal, real-time updates (24-7-365) via web application, data sits in a secure window, supplier portal access, trust seal page impression tracking, trust seal page click tracking, can suspend supplier at click of a button, can reinstate supplier at click of a button, QR code allocation, 128 bit encryption, revoke trust seal/certificate in real-time, live verify, true verification—integration with educational facilities such as universities, technikons, colleges, etc., plugin for professional sites such as LinkedIn, etc.

The listing tool, similarly to the preceding tools, is in a white label, cloud format, capable of providing suppliers a listing on a central directory of qualifying suppliers, each with a qualifying and verified profile as per a preselected set of criteria.

The listing tool structuring includes features such as a secure trust seal that cannot be copied and is domain verified, only preselected members can be imported into the system for trust seal issuing, the conversion of the logo to a trust seal, real-time updating via web application, the banded subject matter (data) is placed in a secure window, allows for preselected supplier portal access, enables trust seal page impression tracking, enables suspension of trust seal page click tracking, enables suspension of supplier at click of a button, enables reinstatement of a supplier at click of a button, enables QR code allocation, enables 128 bit encryption, enables membership management (renew, revoke, re-instate), and monitoring and reporting on location and use of logos from credible members matched with those not vetted.

The listing tool enables a listing of verified suppliers which have already been validated by the trading house in order to have unbiased third party verification for suppliers to access.

It will be appreciated that many variations in detail are possible without departing from the scope and/or spirit of the inventions as claimed in the claims hereinafter, including investigation, assessment and verification of, with incorporation of the corresponding functionality for aspects such as a criminal check—locally and internationally, including, criminal check done against international, national and/or local police databases, criminal check done against sites such as peopleverified.com or similar, criminal check done against sites such as www.ddc.uk.net/criminalcheck or similar, black listing check, including has candidate's employ ever been terminated by the employer, every educational statement is verified, such as e.g. BCom (is) from UCT, check against recognized institutional databases such as the university of cape town's database for student's educational inclusion via student number and id number, a confirmation gets a point, each cv section is checked, personal details, including name and id—verified against a relevant department of home affairs or the like, address—verified against utility bill or google earth, contact number—verified against Telecom provider and two-factor-authentication to ensure number is in current use (candidate to input code to validate), educational qualifications, work experience, id number verified against supplier payroll, name verified against payroll and publicly checked (google search for supplier links and references), testimonials, automated call made to contact number with questions such as “has x name worked in your department, key 1 for yes, 2 for no” (e.g. a yes response gets a point, a no response gets 0 points), email verification sent to employer, requesting written verification of employment of candidate, in addition, scoring to be added, 1 for do not consider employing (bad employee), 5, consider employing (good employee), the verification is given a preselected period of time, if it does not pass a certain predetermined threshold, the candidate is given an opportunity to rectify, if it comes back below a certain threshold for a preselected number of times, a candidate is notified as unsuccessful, the potential employer is notified that the candidate did not make a short list. if the threshold is passed, the candidate then gets verified against specific preselected requirements, such as skills match, vs. personality match, vs. experience match, if a certain threshold is passed, a candidate would receive an interview, this section can be set by employer via the application.

In addition, further functionality could be incorporated for allowing a person or entity to create portfolios for a specific website, with embedded details which, when unauthorized copying is endeavoured off such website, predetermined notification would be displayed, with corresponding preselected subject matter such as reference to the image owner, a verified date, project location and the like, being displayed at least partially across the image. The functionality could further include means for changing such notification and/or enabling such image to be transferred from person and/or entity to another with the use of the functionality.

Other functionality, such as means for identifying “child-friendly” websites with content suitable for children, could also be incorporated, enabling the assessment of websites and incorporation of a suitable trust seal would indicate the levels of safety, provide a child-rating and indicate the origin of the information.

Similarly, further functionality could include verification of legitimate, bona fide comments for products and services and their related websites such as in the entertainment, food and accommodation industry.

1. A computer-implemented system for intelligent verification management between a browser and a web server comprising
a web server, serving up a provider's website and associated web pages via the Internet to potential browsers;
a non-transitory computer readable storage medium, in communication with the web server, storing computer-executable instructions;
a connector configured to establish an encrypted connection between the web server and a browser of such website; and
an accreditor configured to identify, assess, and verify a preselected form of provider accreditation as required by the browser in accordance with set performance criteria;
wherein branded or user data passes between the web server and the browser in a secure, authorised and confidential manner online in accordance with preselected level of confidentiality, integrity, authentication and accreditation.

2. The system as claimed in claim 1, wherein:
the accreditor is further configured to identify, assess, and verify the preselected, browser required form of provider accreditation, in the form of a trust seal, and configured to pass authorised branded and user data between the web server and the browser online in accordance with preselected level of confidentiality, integrity, securitization and authentication; and
wherein the connector is further configured to establish the encrypted connection between the web server and a browser of such website.

3. The system as claimed in claim 2 wherein the accreditor comprises concealed preselected data within a provider's other non-confidential data to communicate visually a positive or negative outcome of a verification process.

4. The system as claimed in claim 1, further comprising a plurality of functionality tools selected from the group comprising a verification management tool configured to include QR scanning verification functionalities using at least one of a computer implemented platform and a cellular implemented platform, a strategic partnering tool, a green intervention tool, a monitoring tool, a mailing tool, a social media platform tool, a printing tool, a trust seal tool, an educational qualification tool, and a listing tool, wherein at least one of the plurality of functionality tools is configured to monitor, verify, and protect a supplier's branded data as well as its strategic partnering, green intervening, social media platforms, original certificates, qualifications, associations and affiliation in their electronic communications, while providing a trust seal therefor.

5. A computer-implemented method for managing intelligent verification between a browser and a specific web server, serving up an associated provider's website and associated web pages containing branded data via the Internet to potential browsers with the use of a non-transitory computer readable storage medium, in communication with the web server and storing computer-executable instructions, the method including the steps of:
establishing an encrypted connection between the web server and a browser of such website;
identifying, assessing and verifying a preselected form of provider accreditation as required by the browser in accordance with set performance criteria; and
ensuring that branded and user data passes between the web server and the browser in a secure, authorised and confidential manner online in accordance with a preselected level of confidentiality, integrity and authentication.

6. The method as claimed in claim 5, further comprising the steps of:
establishing, via a connector, the encrypted connection between the web server and the browser;
identifying, assessing and verifying, via an accreditor, the preselected, browser required form of provider accreditation, the required form including a trust seal; and
passing the authorised branded and user data between the web server and the browser online in accordance with the preselected level of confidentiality, integrity, securitization and authentication.

7. The method as claimed in claim 6, further comprising the step of concealing preselected data within a provider's other non-confidential data to communicate visually a positive or negative outcome of a verification process, wherein the provider's other non-confidential data includes a logo.

8. The method as claimed in claim 5, further comprising at least one of the steps selected from the group comprising managing the verification and protection of branded data using QR scanning verification based on computer implemented and cellular implemented platforms, verifying the strategic partnering of a supplier, verifying the green intervening of a supplier, monitoring the location and use of branded data, reflecting a trust seal of a supplier's associations and affiliation in their electronic communications, verifying a supplier's social media platforms, verifying and printing supplier's original certificates, providing a trust seal and verifying educational qualifications for monitoring verifying and protecting a supplier's branded data including its strategic partnering, green intervening, social media platforms, original certificates, qualifications, associations and affiliation in their electronic communications, while providing the trust seal therefor.

9. A web enabled trust seal for intelligent verification between a browser and a web server on a computer-implemented intelligent verification management system, comprising a web server, serving up a provider's website and associated web pages via the Internet to potential browsers, a non-transitory computer readable storage medium, in communication with the web server, storing computer-executable instructions, means for establishing an encrypted connection between the web server and a browser of such website, and means for identifying, assessing and verifying a preselected form of provider accreditation as required by the browser in accordance with set performance criteria, the trust seal characterised in identifying, assessing and verifying in real time preselected, browser required form of provider accreditation while authorised branded and user data is passed between the web server and the browser online in accordance with a preselected level of confidentiality, integrity, securitization and authentication.

10. The web enabled trust seal for intelligent verification as claimed in claim 9 wherein the means for identifying, assessing and verifying a preselected form of provider accreditation as required by the browser in accordance with set performance criteria comprises a non-transitory computer accessible accreditor and conceal preselected data within a provider's other non-confidential data to communicate visually a positive or negative outcome of a verification process.
